(19) United States
(12) Patent Application Publication
(10) Pub. No.: US 2026/0316098 A1
(43) Pub. Date: Oct. 15, 2026

(54) IRRIGATION SYSTEM

(71) Applicant: Husqvarna AB

(72) Inventors: Rainer KAUPP, Blaubeuren (DE); Christoph SCHENK, Oberdischingen (DE)

(21) Appl. No.: 19/476,485

(22) PCT Filed: Apr. 19, 2024
(86) PCT No.: PCT/EP2024/060738

§ 371 Date: Oct. 17, 2025

(30) Foreign Application Priority Data
Apr. 20, 2023 (EP) 23168865.6

(51) Int. Cl. B05B 3/02; B05B 12/00

(52) U.S. Cl. CPC B05B 3/021; B05B 12/002

(57) ABSTRACT

A method of calibrating a water application device, particularly a sprinkler that includes at least one nozzle. The method includes positioning the at least one nozzle at a first angular position followed by starting an outflow, particularly of wa-ter, from the nozzle. After starting the outflow from the nozzle, a throwing distance of the outflow is adjusted. If the throwing distance substantially corresponds to a target throwing distance, then the throwing distance is confirmed. The method is characterized in that a first flowrate is determined at the confirmed throwing distance. Further, the first flowrate together with the first angular position is stored.

### TECHNICAL FIELD

The present disclosure relates to an irrigation system, particularly including a sprinkler to deliver water to an area with arbitrarily shaped contour for one or more purposes, as well as associated methods for irrigating the area with arbitrarily shaped contour. Additionally, the present disclosure relates to a method of calibrating a water application device, particularly a sprinkler, wherein the water application device comprises at least one nozzle.

### BACKGROUND

An irrigation system, particularly including a sprinkler may be used to irrigate agricultural crops, lawns, gardens, planted areas, landscapes, golf courses, and other areas. The irrigation system may additionally be used for controlling airborne dust. The irrigation system generally includes a sprinkler, a memory, and a controller configured to communicate with the memory. Further, the sprinkler includes a body defining a water channel, a sprinkler head fluidly coupled to the body, at least one nozzle disposed with the sprinkler head, and a valve fluidly coupled with the at least one nozzle.

The irrigation system often involves a method of applying water in a controlled manner in a way similar to rainfall. However, there may be instances in which working with the irrigation system may involve range constraints and other implementation challenges. Such challenges may be more pronounced when the irrigation system may be used to irrigate areas with arbitrarily shaped contour, such as an irregular lawn surface or in other words a lawn surface with irregular contour. To irrigate such complex landscape shapes, a throwing distance of the water jet (or outflow) emanating from at least one nozzle of the sprinkler must be adjustable. Further, a method of calibrating a water application device may be needed which may be usable in connection with such areas with arbitrarily shaped contour.

In the known irrigation systems, the irrigation systems are calibrated by adjusting the throwing distance of the outflow by moving the valve (ball or washer valve) to get different throw distances of the sprinkler. Further, a position of the valve and a position of the sprinkler head corresponding to the adjusted throwing distance is stored in the memory.

An example of a method that automatically calibrates an irrigation system for achieving a desired water flowrate that results in a desired throw distance for the watering streams discharged by the sprinkler heads is provided in U.S. Pat. No. 10,654,062 B2 (hereinafter referred to as '062 reference). The '062 reference provides a method for calibrating the irrigation system comprising adjusting the valve until the flow sensor measures a water flowrate that matches a first predetermined water flowrate This is a first position for the valve. Adjusting the valve opening again by a set amount or until the flow sensor measures a water flowrate that matches a second predetermined water flowrate. This is a second position for the valve. The first predetermined flowrate and the second predetermined water flowrate each corresponds to a throw distance the water stream discharged from the sprinkler head will travel. This relationship between the water flowrate and distance is based on empirical data for the sprinkler. A second equation relating the valve opening to the water flowrate, for a given pressure, is then used to estimate the water effective pressure. Thereby, the '062 discloses a method for calibrating the irrigation system which needs great computing power and a large memory.

An alternative method for manually calibrating or setting up a sprinkler is provided in the PCT application WO 2021/138741 A1 (hereinafter referred to as '741 reference). A sprinkler calibration app is used. When calibrating the sprinkler by using the app, the user can identify corners of an application area to be watered. For the set-up process, the user utilizes angular direction buttons for directing a microcontroller to adjust the angular position of the sprinkler head sprout as well as virtual up/down buttons to adjust the throw distance. The user manipulates these virtual control buttons until the water jet hits a corner of the application area. Then, the user presses a virtual confirmation button within the app and the microcontroller of the device memorizes the sprinkler head spout angular position, the pressure at the spout and optionally the % open position of the spout. The process is repeated for all corners until an application area is defined. Thereby, the '471 reference provides a method for calibrating the sprinkler by actively measuring by using a pressure sensor, and memorizing the pressure at the spout together with the angular position of the spout and optionally the %open position of the spout. Hence, the '471 reference discloses that solely a pressure sensor and a sensor for determining the %open position of the spout are necessary for calibrating the sprinkler. Additionally, the '471 reference does not propose using any other sensor or determining any other value(s) during the set-up process or during a later use of the sprinkler.

### SUMMARY OF THE INVENTION

In view of the above, it is an objective of the present invention to solve or at least reduce the drawbacks discussed above. The objective is at least partially achieved by an improved method of calibrating a water application device, particularly a sprinkler that includes at least one nozzle.

According to an aspect of the present invention, the method includes positioning the at least one nozzle at a first angular position followed by starting an outflow, particularly of water, from the nozzle. After starting the outflow from the nozzle, a throwing distance of the outflow is adjusted. If the throwing distance substantially corresponds to a target throwing distance, then the throwing distance is confirmed. The method is characterized in that a first flowrate is determined at the confirmed throwing distance. Further, the first flowrate together with the first angular position is stored.

Thus, the present disclosure provides a method to calibrate the water application device, particularly the sprinkler. The method may allow the water application device to selectively and precisely irrigate one or more zones in an area with arbitrarily shaped contour, such that each of the one or more zones may be at different distances from the water application device. The method allows a determination of flowrate for different zones in the area with arbitrarily shaped contour. The method may allow for an efficient and quick control, adjustment and calibration of the water application device to water different zones in the area with arbitrarily shaped contour. The method may facilitate judicious use of water by precisely irrigating the area with arbitrarily shaped contour as per requirement. Further, the method may facilitate efficient irrigation of the area with arbitrarily shaped contour.

The at least one nozzle is positioned at the first angular position according to the present invention. This may denote that if an arc shaped contour is assumed in front of the water application device, with the water application device disposed at the center of the arc along the diameter of the arc, then the first angular position of the at least one nozzle may correspond to watering the diametrical extreme of the arc positioned to the left or right of the water application device. Likewise, the at least one nozzle may be rotated to different angular positions to water along the complete arc.

The regular shaped contour like arc shaped contour may not be available during implementation of the water application device. However, to water the area with irregular or arbitrarily shaped contour, or to water different zones in the area with arbitrarily shaped contour, the at least one nozzle may rotate in the same manner as if watering along the regular arc shaped contour. Further, during the rotation, the at least one nozzle may be supplemented with adjustments in operational parameters such as, the flowrate through the at least one nozzle, in order to produce different throwing distances that may be required to irrigate different zones in the area with arbitrarily shaped contour.

Further, the throwing distance may be defined as the distance, which the outflow or water jet emanating from the at least one nozzle, may travel. The throwing distance may be measured with respect to a central axis of the water application device or the sprinkler. The central axis may further be defined as the longitudinal axis of the water application device which may divide the water application device into two equal halves or mirror images.

Further, the target throwing distance may be defined as the distance, which the outflow or water jet emanating from the at least one nozzle may travel to water different zones of the area with arbitrarily shaped contour. Again, the target throwing distance may be measured with respect to the central axis of the water application device or the sprinkler. Further, the target throwing distance may increase or decrease as per the shape of the contour. In other words, the target throwing distance may be a variable parameter.

Determining the throwing distance according to the present invention may particularly denote that a user determines the throwing distance by visually evaluating the distance which the water flow travels before the water flow hits the ground. Further, the target throwing distance may be set and adjusted by the user dependent on the individual needs at a specific angular position. Further, the user may visually evaluate if the throwing distance substantially corresponds to a target throwing distance. Therefore, the user may stand in the area to be watered and observes the water application device and the throwing distance. If the user decides that at the respective angular position, the throwing distance corresponds to the target throwing distance, e.g., the water flow reaches the maximum or desired target point in the area to be watered, the user may confirm the throwing distance in an easy and intuitive way by pressing a confirmation button, e.g., on his mobile device.

Further, the confirmed throwing distance may be the throwing distance that may substantially correspond to the target throwing distance.

Further, the first flowrate may be defined as the flowrate of the at least one nozzle that may correspond to the outflow of water necessary to reach the confirmed throwing distance when the at least one nozzle is positioned at the first angular position.

Further, the first flowrate together with the first angular position is stored according to the present invention and this may denote that the first flowrate together with the first angular position is included in the program instructions stored in a memory. Stored together with according to the present invention may particularly denote that the first flowrate is related to the first angular position. Thereby, a dependency solely between the flowrate and the angular position is stored.

According to an exemplary embodiment of the invention, the adjusting of the throwing distance is a manually adjusting of the throwing distance and/or the adjusting of the throwing distance is performed by a user, particularly via a graphical user interface, more particularly running on a mobile device. The user may manually adjust the flowrate by controlling a valve opening by means of an input unit. Particularly, by manually controlling the valve opening by means of a mobile application. Particularly, the user may manually choose between plus for opening the valve opening and minus for closing the valve opening. The manual adjustment of the flowrate may be based on visual and/or graphical observation of the arbitrarily shaped contour to be watered. Further, the manual adjustment of the flowrate may be done to adjust the throwing distance of the at least one nozzle by opening respectively closing the valve opening.

In other words, the user may manually increase or decrease the throwing distance of the at least one nozzle which is positioned at the particular angular position by entering a control signal for opening or closing the valve opening dependent on the desired increase or decrease of the throwing distance. The manual increase or decrease of the throwing distance of the at least one nozzle may be done to allow the outflow of the at least one nozzle to reach the target throwing distance. The manual increase or decrease of the throwing distance of the at least one nozzle may be done by visual and/or graphical observation and/or analysis. For example, the user may observe that by increasing the throwing distance, the outflow is reaching beyond the target throwing distance, or the user may observe that a further increase in the throwing distance of the at least one nozzle is required to allow the outflow to reach the target throwing distance. Accordingly, the user may manually adjust the throwing distance by means of a mobile device by using a graphical user interface. The graphical user interface may comprise a button, e.g., marked with a plus, for increasing the throwing distance, and a button, e.g., marked with minus, for decreasing the throwing distance. Thereby, an easy to implement and intuitive way of calibrating the water application device may be providable.

According to an exemplary embodiment of the invention, a switch may be provided with the water application device. The switch, when pressed by the user may allow manual adjustment of the throwing distance of the at least one nozzle of the water application device. This may provide the possibility to calibrate the water application device without the need of a mobile device and directly on the water application device.

According to an exemplary embodiment of the invention, a display interface or a touchscreen panel may be provided with the water application device. The display interface or the touch screen panel may display plus and minus buttons to adjust the throwing distance of the at least one nozzle. The user may press the plus or minus buttons as per requirement to accordingly increase or decrease the throwing distance of the at least one nozzle at the particular angular position.

According to an exemplary embodiment of the invention, the steps of positioning, starting, adjusting, confirming, determining, and storing are repeated until the at least one nozzle is calibrated at a pre-determined number of angular positions. A plurality of steps involved in the calibration of the at least one nozzle may be repeated until the water application device is calibrated to completely irrigate the area with arbitrarily shaped contour, particularly the zones defined along the arbitrarily shaped contour which may be at different distances from the water application device. The repetition of steps at the pre-determined number of angular positions may further facilitate precise and accurate calibrating the irrigation or watering, thereby preventing wastage of water.

According to an exemplary embodiment of the invention, the method further includes stopping the outflow from the nozzle and subsequently positioning the at least one nozzle at a second angular position. The first angular position and the second angular position are distanced from each other by a pre-set angular distance. The at least one nozzle may be positioned at a pre-determined number of angular positions, such that the flowrate through the at least one nozzle at pre-determined number of angular positions may be determined. Further, the pre-determined number of angular positions may cover up the complete area with the arbitrarily shaped contour, particularly the complete contour of the area with the arbitrarily shaped contour. Hence, the water application device may be efficiently calibrated for irrigating the area with the arbitrarily shaped contour.

According to an exemplary embodiment of the invention, the first flowrate at the confirmed throwing distance is determined by a flow sensor. The flow sensor may measure the flowrate through the at least one nozzle when the target throwing distance is reached and confirmed by the user. The flowrate measured by the flow sensor along with the corresponding angular position of the at least one nozzle may then be stored for future usage. In other words, the combination of the flowrate and the angular position of the at least one nozzle may be stored in the memory.

According to an exemplary embodiment of the invention, the flow sensor may be a mechanical flow sensor. According to an exemplary embodiment of the invention, the flow sensor may be a vortex flow sensor. According to an exemplary embodiment of the invention, the flow sensor may be an ultrasonic flow sensor. According to an exemplary embodiment of the invention, the flow sensor may be a magnetic flow sensor. According to an exemplary embodiment of the invention, one or more flow sensors may be used to measure the flowrate through the at least one nozzle.

According to an exemplary embodiment of the invention, the adjusting of the throwing distance of the outflow is performed by a user, particularly by using a graphical user interface, more particularly running on a mobile device. The user may use the graphical user interface running on the mobile device, laptop, and the like to adjustably control the throwing distance. Particularly, the graphical user interface may provide various graphical representations of an increase or a decrease of the throwing distance. Particularly, by a “plus button” representing an increase of the throw distance and a “minus button” representing a decrease of the throwing distance. The user with the help of the mobile device may remotely adjust the throwing distance of the outflow from the at least one nozzle. Further, the mobile device may employ wireless communication technology to allow the user to adjust the throwing distance of the outflow.

According to an exemplary embodiment of the invention, the user may operate the plus icon and/or the minus icon in the mobile device application to increase or decrease the throwing distance of the outflow emanating from the at least one nozzle to obtain the target throwing distance when the at least one nozzle may already be positioned at the particular angular position.

According to an exemplary embodiment of the invention, the graphical user interface may include a main window containing a multitude of options. At least one of the options may represent the flowrate for the at least one nozzle of the water application device, particularly sprinkler, along with the corresponding angular position in the format of angular position-flowrate. For example, the option displaying 0°-525 l/h may represent that at 0 degrees angular position a flowrate of 525 liters per hour is stored.

According to an exemplary embodiment of the invention, the wireless technology may be satellite communication, Bluetooth, Wi-Fi, IoT (internet of things), or other well-known wireless technologies.

According to an exemplary embodiment of the invention, the target throwing distance is determined by a user, particularly by visually determining the target throwing distance. The user may be physically present at the irrigation area or may visualize a map of the irrigation area, particularly in the mobile device located at a remote location from the irrigation area to visualize the target throwing distance.

According to an exemplary embodiment of the invention, the user may employ various measurement means to determine the various target throwing distances, particularly along the contour of the arbitrarily shaped area. The measurement means may be a conventional measuring tape, sonar sensors, or other conventional means known and understood in the related art.

According to an exemplary embodiment of the invention, the confirming of the throwing distance includes manually confirming the throwing distance, particularly by using a graphical user interface, in particular running on a mobile device. The user may visually recognize that the throwing distance substantially corresponds to the target throwing distance which the user intended to reach. Alternatively, the user may visualize the real-time image or video of the irrigation area, particularly the area with the arbitrarily shaped contour. The user may visualize the real-time image or video of the water application device operation such as the outflow and visually confirm the throwing distance.

According to an exemplary embodiment of the invention, the user may analyze the irrigation status at pre-determined zones of the irrigation area via the mobile device and then confirm the throwing distance. For example, a software program on the mobile device may be able to gather the moisture data of the pre-determined zone or the zone in focus using signals from one or more sensors such as moisture sensors. The moisture data of the pre-determined zone may indicate watering of the zone by the water application device. This may particularly indicate that the outflow was able to reach the zone, thereby assisting in determining if the throwing distance substantially corresponds to the target throwing distance.

According to an exemplary embodiment of the invention, a controller is configured to perform the method of calibrating the water application device. The controller may be configured to calibrate and further control the working of the water application device. The controller may be responsible to carry out each of the method steps involved in the calibration of the water application device. The controller may include one or more processors configured to execute program instructions stored in a memory to perform each of the method steps involved in the calibration of the water application device. The controller may be communicably coupled to the water application device, and other components that may work together to operate the water application device.

According to an exemplary embodiment of the invention, the controller may be located within or outside the water application device. According to an exemplary embodiment of the invention, the controller may be communicably coupled to the water application device using wired or wireless technologies.

According to a further aspect of the present invention, an irrigation system is provided. The irrigation system includes a water application device, a controller configured to perform the method of calibrating the water application device, and a memory. The controller is further configured to communicate with the memory. Further, the first flowrate together with the first angular position is stored in the memory. Thereby, an irrigation system which is easy and fail-safe calibratable by a user, particularly an inexperienced user, and which may reliably water also arbitrarily shaped areas, may be providable.

According to an exemplary embodiment of the present invention, the irrigation system includes the water application device, the controller configured to perform the method of calibrating the water application device, the memory, a drive mechanism, at least one motor, a power supply, a sensor particularly a flow sensor, a valve, and possibly other components that may work in conjunction to calibrate the water application device, and further operate the water application device to water or irrigate the irrigation areas with the arbitrary shaped contour. The water application device may be a part of an intelligent irrigation system that includes the controller, one or more operational parameter sensors such as, flow sensors, and other electronic circuitries to execute the method to calibrate the water application device.

According to an exemplary embodiment of the invention, the irrigation system may be equally potent or capable to irrigate with a mixture of water and fertilizer, or other fluid.

According to an exemplary embodiment of the invention, the memory may be a RAM, a ROM, a flash memory, or other tangible data storage medium.

According to an exemplary embodiment of the invention, the at least one motor may comprise two motors such that one motor may be a part of the drive mechanism while the other motor may be used to control the position of the valve. Further, the motor which is part of the drive mechanism may possibly be an electric motor or a hydraulic motor. Further, the motor which may be used to control the position of the valve may possibly be a stepper motor, or a servo motor.

According to an exemplary embodiment of the invention, the valve may comprise a plurality of valves. Additionally, the plurality of valves may be components of a multiplexor valve, rather than separate valves. According to an exemplary embodiment of the invention, each of the plurality of valves may be actuated using one or more motors. Additionally, each of the plurality of valves may control a flow of water to the at least one nozzle. For example, a first valve may be used to control the flow of water to a first nozzle. Likewise, a second valve may be used to control the flow of water to a second nozzle.

According to an exemplary embodiment of the invention, the flow of water to each of the at least one nozzle may be controlled independently of the flow of water to the other nozzles of the at least one nozzle through the actuation of the plurality of valves. As a result, individual nozzles may be turned on or off, or the amount of fluid through the nozzles may be adjusted.

According to an exemplary embodiment of the invention, the water application device is a sprinkler. The sprinkler includes a body defining a water channel. The water channel is defined between an inlet and an outlet of the body to allow a flow of water through it. Further, a sprinkler head is fluidly coupled to the body and at least one nozzle is disposed with the sprinkler head. The sprinkler may find application in outdoor (such as gardens, lawns, and the like) or indoor areas to supply or spray water in a controlled manner as per the requirement of the area. The sprinkler of the present invention may be particularly useful in supplying or spraying water to the area with the arbitrarily shaped contour. The sprinkler may be well-connected to a water source, say an underground piping system that may supply water to the water channel of the sprinkler.

According to an exemplary embodiment of the invention, the sprinkler may be designed for use as an in-ground sprinkler. According to an exemplary embodiment of the invention, the sprinkler may be fixed to a ground surface. According to an exemplary embodiment of the invention, the sprinkling may also be used for above-ground surface liquid operations.

According to an exemplary embodiment of the invention, the sprinkler head may be manufactured by three-dimensional printing (also known as additive manufacturing or 3D printing). Use of three-dimensional printing (alternatively, 3D printing) provides versatility of using different materials along with low lead-time in manufacturing and design of the sprinkler head.

According to an exemplary embodiment of the invention, the at least one nozzle may have similar or different cross-sections. Further, when the at least one nozzle may have different cross-section, then each of the at least one nozzle may have different flow characteristics. According to an exemplary embodiment of the invention, the at least one nozzle may have circular or oval or any similar shaped cross-section. The at least one nozzle with circular or oval cross-section may be well suited for providing desired water distribution at long throwing distance or wide throwing distance. According to an exemplary embodiment of the invention, the at least one nozzle may have a drop-shaped cross-section. The drop-shape cross-section may be referred to a cross-section formed as a cone with a hemispherical base. Further, the droplet shape of the cross-section of the at least one nozzle may imply that the section opening is narrowing at its one end while it forms an approximate circular contour on its other end. Further, the at least one nozzle with drop-shaped cross-section may be well suited for providing desired water distribution at narrow or shorter throwing distances. According to an exemplary embodiment of the invention, the at least one nozzle may have a combination of oval and drop-shaped cross-sections. In other words, some of the at least one nozzle may have the oval shaped cross-section and the remaining ones of the at least one nozzle may have drop-shaped cross-section.

According to an exemplary embodiment of the invention, the at least one nozzle may be any number of nozzles, as per the requirement. For example, the at least one nozzle may be five nozzles. Alternatively, the at least one nozzle may be one single nozzle.

According to an exemplary embodiment of the invention, the angular position of the at least one nozzle is adjustable with adjustment in position of the sprinkler head. The angular adjustment of the at least one nozzle may improve or alter the sprinkling range, trajectory, or throwing distances of the outflow on the irrigation area particularly with the arbitrarily shaped contour. Further, the angular adjustment of the at least one nozzle may be beneficial for covering the entire irrigation area, particularly the entire irrigation contour. The at least one nozzle may be fixed with respect to the sprinkler head and the sprinkler head may rotate to facilitate irrigation of the area with the arbitrarily shaped contour.

According to an exemplary embodiment of the invention, a magnitude of the throwing distance of at least one nozzle at a particular angular position is directly linked to the flowrate through the at least one nozzle. In other words, the magnitude of the throwing distance of the at least one nozzle at the particular angular position may be directly proportional to the flowrate of the at least one nozzle. For example, if the angular position of the at least one nozzle is fixed, then a low flowrate through the at least one nozzle may lead to a lower throwing distance. Likewise, a higher flowrate through the at least one nozzle may lead to the higher throwing distance.

According to an exemplary embodiment of the invention, a flow sensor determines the flowrate through the at least one nozzle, if the throwing distance substantially corresponds to a target throwing distance. The flow sensor may be configured to determine or measure the flowrate only at the confirmed throwing distance. This may lead to precise measurement. Further, the flow sensor may consume less power to operate. Further, only required flowrate data may be sent for further processing. This may lead to a less complex algorithm which may otherwise, e.g., require to average out the flowrates of the outflow at different time frames.

According to an exemplary embodiment of the invention, the controller is communicably coupled with the flow sensor. The controller may receive the flowrates at different angular positions and may send the flowrate and the corresponding angular position for storage to the memory. Further, the controller may be communicably coupled to the flow sensor by wired or wireless technology.

Before discussing the invention with the help of the drawings, the invention will be briefly discussed in general. A flowrate is measured and saved. The flowrate may be in accordance with the throwing distance. Further, different flowrates and the angular positions of the sprinkler head give the lawn surface contour (or the arbitrarily shaped contour) which requires irrigation. With this invention, position of the valve (ball or washer) is not saved.

The irrigation system and the method to calibrate the water application device of the irrigation system according to the present invention may lead to less torque on the valve and may further lead to less consumption of electrical power. The irrigation system and the method to calibrate the water application device of the irrigation system according to the present invention may lead to fast adjustment of the flowrate. The irrigation system and the method to calibrate the water application device of the irrigation system according to the present invention may result in a simple sealing of the valve and therefore of the irrigation system.

According to an exemplary embodiment of the invention, the valve position is controlled and adjusted by measuring the flowrate for different lawn (or irrigation area) contours.

Other features and aspects of this invention will be apparent from the following description and the accompanying drawings.

### BRIEF DESCRIPTION OF THE DRAWINGS

The invention will be described in more detail with reference to the enclosed drawings, wherein:

FIG. 1 illustrates a schematic diagram of an irrigation system in accordance with an exemplary embodiment of the present disclosure;

FIG. 2 illustrates a simplified drawing illustrating exemplary throwing distances from the at least one nozzle of the sprinkler in accordance with an exemplary embodiment of the present disclosure;

FIG. 3 illustrates a flowchart illustrating a method of calibrating a sprinkler in accordance with an exemplary embodiment of the present disclosure;

FIG. 4 illustrates a schematic diagram of an irrigation system of FIG. 1 communicably coupled with a mobile device in accordance with an exemplary embodiment of the present disclosure;

FIG. 5 illustrates a simplified drawing illustrating an exemplary spot irrigation pattern at different throwing distances from a single spot nozzle of the sprinkler in accordance with an exemplary embodiment of the present disclosure; and

FIG. 6 illustrates a simplified drawing illustrating an exemplary strip irrigation pattern at different throwing distances from a further single spot nozzle of the sprinkler in accordance with an exemplary embodiment of the present disclosure.

### DETAILED DESCRIPTION OF THE DRAWINGS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention may be utilized in other embodiments and even other types of structures and/or methods. In the drawings, like numbers refer to like elements.

Certain terminology is used herein for convenience only and is not to be taken as a limitation on the invention. For example, “upper”, “lower”, “front”, “rear”, “side”, “longitudinal”, “lateral”, “transverse”, “upwards”, “downwards”, “forward”, “backward”, “sideward”, “left,” “right,” “horizontal,” “vertical,” “upward”, “inner”, “outer”, “inward”, “outward”, “top”, “bottom”, “higher”, “above”, “below”, “central”, “middle”, “intermediate”, “between”, “end”, “adjacent”, “proximate”, “near”, “distal”, “remote”, “radial”, “circumferential”, or the like, merely describe the configuration shown in the Figures. Indeed, the components may be oriented in any direction and the terminology, therefore, should be understood as encompassing such variations unless specified otherwise.

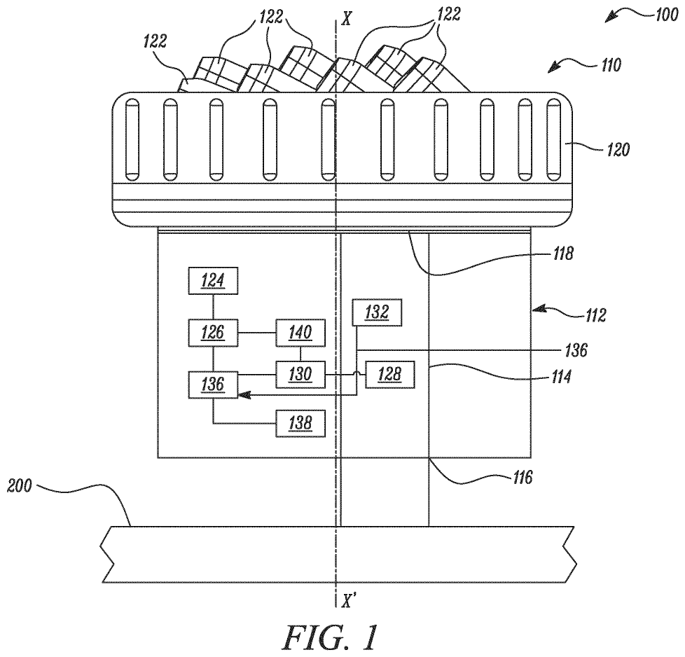

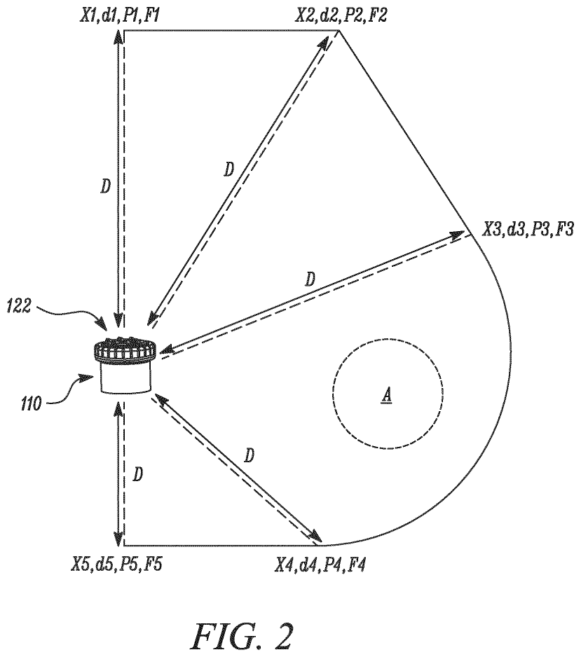

FIG. 1 illustrates a schematic diagram of an irrigation system 100 according to an exemplary embodiment of the present invention. The irrigation system 100 may be used to irrigate an area A (as shown in FIG. 2), such as a garden, a lawn, and the like. The irrigation system 100 may be used to irrigate an area A with an arbitrarily shaped contour, such as the area having irregular shape of perimeter or border. In other words, the contour of the area A may have different zones X1, X2, X3, X4, X5 (as shown in FIG. 2) along the contour such that each of the zones may be at a different distance with respect to the irrigation system 100. The irrigation system 100 according to the disclosure of the present invention may be configured to irrigate using water, as water is the most frequently used fluid for irrigation.

The irrigation system 100 includes a water application device 110. The water application device 110 shown in FIG. 1 is a sprinkler 110. For the purpose of the present disclosure, the water application device 110 is now interchangeably written as the sprinkler 110. As illustrated in FIG. 1, the sprinkler 110 includes a body 112. The body 112 defines a water channel 114. The water channel 114 is defined between an inlet 116 and an outlet 118 of the body 112. The inlet 116 of the body 112 is coupled to a water supply line 200, such as a hose or an in-ground piping. The water supply line 200 may provide a pressurized source of water to the inlet 116 of the body 112. Further, the water channel 114 may allow a flow of water from the inlet 116 to the outlet 118.

As also illustrated in FIG. 1, the sprinkler 110 further includes a sprinkler head 120. The sprinkler head 120 is fluidly coupled to the body 112. The body 112 may further provide support for the sprinkler head 120. The sprinkler head 120 is fluidly coupled to the water channel 114 around the outlet 118. Further, at least one nozzle 122 is disposed with the sprinkler head 120. In other words, the sprinkler head 120 supports the at least one nozzle 122. The present disclosure illustrates seven nozzles 122 (as shown in FIG. 1). The pressurized water received from the water supply line 200 may reach the at least one nozzle 122 through the sprinkler head 120 which further receives water from the water channel 114. Further, the at least one nozzle 122 may produce an outflow of the water to be directed to the area A having an arbitrarily shaped contour for irrigation. Further, the at least one nozzle 122 may produce the outflow of the water to be directed to different zones X1, X2, X3, X4, X5 along the contour of the area A.

With continued reference to FIG. 1, the sprinkler head 120 is a rotary sprinkler head. The sprinkler head 120 may rotate relative to the body 112. An angular position of the at least one nozzle 122 may be adjustable with adjustment in position of the sprinkler head 120. The angular adjustment of the at least one nozzle 122 may improve or alter the sprinkling range, trajectory, or throwing distances of the outflow on the area A having the arbitrarily shaped contour. Further, the angular adjustment of the at least one nozzle 122 may be beneficial for covering the entire area A, particularly the entire irrigation contour. The at least one nozzle 122 may be fixed with respect to the sprinkler head 120 and the sprinkler head 120 may rotate to facilitate irrigation of the area A with the arbitrarily shaped contour.

In other words, the rotation of the sprinkler head 120 may lead to the angular adjustment of the at least one nozzle 122. For example, the rotation of the sprinkler head 120 may rotate the at least one nozzle 122 to a first angular position P1, a second angular position P2, a third angular position P3, a fourth angular position P4, and a fifth angular position P5 and may allow the at least one nozzle 122 to water or irrigate the zones X1, X2, X3, X4, and X5, respectively, as shown in FIG. 2, of the area A.

The irrigation system 100 further includes a drive mechanism 124 mounted to the sprinkler 110. The drive mechanism 124 may be configured to drive the rotation of the sprinkler head 120 about a central axis X-X′ that extends along the longitudinal direction of the sprinkler 110. The drive mechanism 124 includes a motor 126 that may drive the rotation of the sprinkler head 120 about the axis X-X′ through a suitable gear arrangement. The drive mechanism 124 may be configured to drive the rotation of the sprinkler head 120 and resultantly to drive the rotation of the at least one nozzle 122 to different angular positions, such as the first angular position P1, the second angular position P2, the third angular position P3, the fourth angular position P4, and the fifth angular position P5.

As shown in FIG. 1, the irrigation system 100 further includes a valve 128. The valve 128 is mounted to the sprinkler 110 and controls the water flow through the water channel 114. Further, the valve 128 may control a flow through the at least one nozzle 122. The valve 128 may allow for example, a first flowrate F1, a second flowrate F2, a third flowrate F3, a fourth flowrate F4, and a fifth flowrate F5 through the at least one nozzle 122 (as shown in FIG. 2).

Further, the valve 128 may have an open position, a closed position, and a plurality of intermediatory positions. In the open position of the valve 128, the water may be free to travel from the water supply line 200 to the at least one nozzle 122. In the closed position of the valve 128, the water may be substantially entirely prevented to travel from the water supply line 200 to the at least one nozzle 122. In intermediatory positions, the flowrate of the water through the at least one nozzle 122 may be set to a value that may be less than the maximum flowrate resulting from the valve 128 being in the open position. As a result, the valve 128 may be used to adjust the flow of the water through the at least one nozzle 122 to be set to a desired level, such as the first flowrate F1, the second flowrate F2, the third flowrate F3, the fourth flowrate F4, and the fifth flowrate F5. This may allow for greater control over the outflow produced by the at least one nozzle 122.

Further, the position of the valve 128 is controlled by a motor 130. Further, the valve 128 is positioned in the body 112 of the sprinkler 110.

Further, the irrigation system 100 includes a flow sensor 132 that determines or measures the flowrate through the at least one nozzle 122. However, the flow sensor 132 may be configured to measure or determine the flowrate only when a throwing distance D (as shown in FIG. 2) of the outflow through the at least one nozzle 122, or simply the throwing distance D of the at least one nozzle 122 substantially corresponds to a target throwing distance d. The target throwing distance d may be a first target throwing distance d1, a second target throwing distance d2, a third target throwing distance d3, a fourth target throwing distance d4, and a fifth target throwing distance d5, respectively, i.e., d=d1, d2, d3, d4, d5. The first target throwing distance d1, the second target throwing distance d2, the third target throwing distance d3, the fourth target throwing distance d4, and the fifth target throwing distance d5 may be different in magnitude. Alternatively, at least two of the target throwing distances d may be substantially equal dependent on requirements of the area A. The first target throwing distance d1, the second target throwing distance d2, the third target throwing distance d3, the fourth target throwing distance d4, and the fifth target throwing distance d5 may correspond to zones X1, X2, X3, X4, and X5 respectively, of the arbitrarily shaped area A. Thus, the flow sensor 132 may be configured to measure or determine the flowrate only when D=d, wherein d=d1, d2, d3, d4, d5.

This may be particularly beneficial for the calibration of the sprinkler 110 to irrigate the area A with the arbitrarily shaped contour or to irrigate the zones X1, X2, X3, X4, and X5 of the area A as this may give the exact flowrate, namely the first flowrate F1, the second flowrate F2, the third flowrate F3, the fourth flowrate F4, or the fifth flowrate F5, required through the at least one nozzle 122 to achieve the target throwing distance d=d1, d2, d3, d4, d5, at the respective known angular position, such as the first angular position P1, the second angular position P2, the third angular position P3, the fourth angular position P4, and the fifth angular position P5 of the at least one nozzle 122.

The throwing distance D of at least one nozzle 122 at a particular angular position, such as the first angular position P1, the second angular position P2, the third angular position P3, the fourth angular position P4, and the fifth angular position P5 may be directly linked to the respective flowrate, namely the first flowrate F1, the second flowrate F2, the third flowrate F3, the fourth flowrate F4, or the fifth flowrate F5 through the at least one nozzle 122.

In other words, the magnitude of the throwing distance D of the at least one nozzle 122 at the particular angular position, such as the first angular position P1, the second angular position P2, the third angular position P3, the fourth angular position P4, and the fifth angular position P5 may be directly proportional to the flowrate dependent on the pressure, namely the first flowrate F1, the second flowrate F2, the third flowrate F3, the fourth flowrate F4, or the fifth flowrate F5 through the at least one nozzle 122. For example, a low flowrate through the at least one nozzle 122 may lead to a lower throwing distance D. Likewise, a higher flowrate through the at least one nozzle 122 may lead to the higher throwing distance D.

Further, this flow sensor 132 according to the disclosure of the present invention may allow a precise measurement of the flowrate. Further, the flow sensor 132 may consume less power to operate. Further, only required data of the flowrate may be sent further for processing, leading to less complex algorithms which may otherwise require to average out the flowrates of the outflow at different time frames. As shown in FIG. 1, the flow sensor 132 is located downstream of the valve 128 in the direction of flow of the water. Further, the flow sensor 132 produces an output signal 134 that is representative of the flowrate measured by the flow sensor 132.

With continued reference to FIG. 1, the irrigation system 100 further includes a controller 136 and a memory 138. The controller 136 is configured to communicate with the memory 138. For example, the controller 136 may be configured to communicate the first flowrate F1 together with the first angular position P1 to the memory 138. The memory 138 may further store the first flowrate F1 together with the first angular position P1 for later retrieval of this information by the controller 136.

The controller 136 may represent one or more processors and circuitry used to perform functions, such as to calibrate the sprinkler 110, and to operate the sprinkler 110 during regular usage or application. The processor of the controller 136 may be configured to execute sprinkler or watering program instructions stored in the memory 138 and perform method steps described herein responsive to the execution of the program instructions.

Further, the program instructions may include different valve settings such as the flowrate, but not the opening position of the valve 128, and the controller 136 may control the valve 128 in response to the valve setting. The valve setting may map a desired flowrate, namely the first flowrate F1, the second flowrate F2, the third flowrate F3, the fourth flowrate F4, or the fifth flowrate F5 through the valve 128 to a specific angular position P. This may be provided for a series of angular positions, namely the first angular position P1, the second angular position P2, the third angular position P3, the fourth angular position P4, and the fifth angular position P5 of the at least one nozzle 122. For example, when the angular position may be 32° and the desired flowrate may be 595 liters per hour, the valve position of the valve 128 is adjusted until the desired flowrate of 595 liters is met.

Further, the program instructions may include the rotation speed settings that may set the rotational speed of the sprinkler head 120. Execution of the program instructions by the controller 136 may generate control signals to the motor 126 based on the rotation speed settings that may be used to control the motor 126.

Further, the irrigation system 100 includes a power supply 140, such as a battery, a capacitor, a solar cell, or other source of electrical energy, that may provide power to the processor of the controller 136, the motor 126, the motor 130, the flow sensor 132 and/or another component of the sprinkler 110 requiring electrical energy.

The irrigation system 100 includes the sprinkler 110, the controller 136, the memory 138, the drive mechanism 124, the motor 126, the motor 130, the power supply 140, the flow sensor 132 and the valve 128 that may work in conjunction to calibrate the sprinkler 110, and further operate the sprinkler 110 to water or irrigate the irrigation area A with the arbitrary shaped contour. For example, the flow sensor 132 may measure the flowrate and send the output signal 134 that is representative of the flowrate to the controller 136, which may further send it to the memory 138 for storage.

The controller 136 may be communicably coupled with the flow sensor 132. The controller 136 may receive the flowrates at different angular positions and may send the flowrate and the corresponding angular position for storage to the memory 138. Further, the controller 136 may be communicably coupled to the flow sensor 132 by any wired or wireless technology.

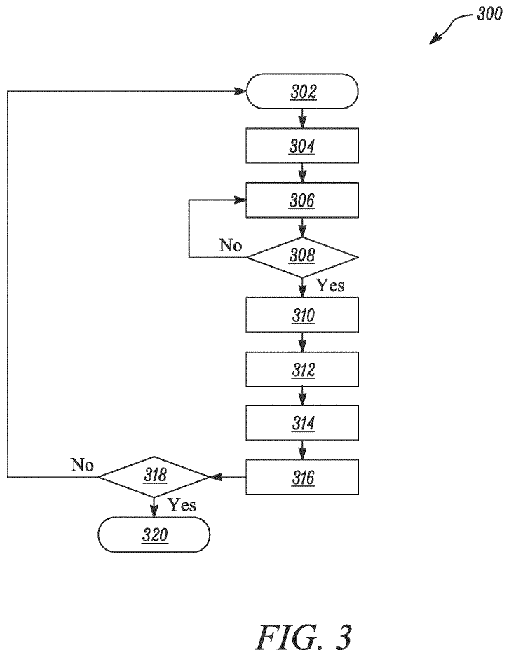

The sprinkler 110, thus is a part of an intelligent irrigation system 100 that includes the controller 136, the flow sensor 132, and other electronic circuitries to execute a method 300 (as shown in FIG. 3) of calibrating the sprinkler 110.

FIG. 2 illustrates a simplified drawing illustrating exemplary outflow from the at least one nozzle 122 of the sprinkler 110 with the throwing distance D according to an exemplary embodiment of the present invention. The sprinkler 110 is configured to irrigate various zones X1, X2, X3, X4, X5 of the area A. The area A may correspond to a garden or a lawn with the arbitrarily shaped contour. As an illustrative example, the zone X1 requires the target throwing distance d1=8 meters for irrigation. The zone X2 may require the target throwing distance d2=9.4 meters for irrigation. The zone X3 may require the target throwing distance d3=8.5 meters for irrigation. The zone X4 may require the target throwing distance d4=6 meters for irrigation. The zone X5 may require the target throwing distance d5=4 meters for irrigation.

Further according to an illustrative example, to irrigate the zone X1, the at least one nozzle 122 may be positioned at the first angular position P1=0°. Further, to irrigate the zone X2, the at least one nozzle 122 may be positioned at the second angular position P2=32°. Further, to irrigate the zone X3, the at least one nozzle 122 may be positioned at the third angular position P3=68°. Further, to irrigate the zone X4, the at least one nozzle 122 may be positioned at the fourth angular position P4=132°. Further, to irrigate the zone X5, the at least one nozzle 122 may be positioned at the fifth angular position P5=180°.

According to an illustrative example, the outflow from the at least one nozzle 122 may be started to irrigate the zone X1 with the at least one nozzle 122 at the first angular position P″=0°. During the calibration process of the sprinkler 110, the first flowrate F1 is determined using the flow sensor 132. The first flowrate F1 is exemplarily determined to be 525 liters per hour. The first flowrate F1 and the first angular position P1 are stored in the memory 138. Further, during the watering operation of the calibrated sprinkler 110, the controller 136 may retrieve the required first flowrate F1 and the first angular position P1 from the memory 138 to enable the sprinkler 110 to water or irrigate the zone X1 with the desired flowrate F1 and thereby at the target throwing distance d1=8 meters.

Likewise according to an illustrative example, the outflow from the at least one nozzle 122 may be started to irrigate the zone X2 with the at least one nozzle 122 at the second angular position P2=32°. During the calibration process of the sprinkler 110, the second flowrate F2 is determined using the flow sensor 132. The second flowrate F2 may be determined to be 595 liters per hour. The second flowrate F2 and the second angular position P2 are stored in the memory 138. Further, during the watering operation of the calibrated sprinkler 110, the controller 136 retrieves the required second flowrate F2 and the second angular position P2 from the memory 138 to enable the sprinkler 110 to water or irrigate the zone X2 with the desired second flowrate F2 and thereby at the target throwing distance d2=9.4 meters.

Likewise according to an illustrative example, the outflow from the at least one nozzle 122 is started to irrigate the zone X3 with the at least one nozzle 122 at the third angular position P3=68°. During the calibration process of the sprinkler 110, the third flowrate F3 is determined using the flow sensor 132. The third flowrate F3 may be determined to be 550 liters per hour. The third flowrate F3 and the third angular position P3 are stored in the memory 138. Further, during the watering operation of the calibrated sprinkler 110, the controller 136 may retrieve the required third flowrate F3 and the third angular position P3 from the memory 138 to enable the sprinkler 110 to water or irrigate the zone X3 with the desired third flowrate F3 and thereby at the target throwing distance d3=8.5 meters.

Likewise according to an illustrative example, the outflow from the at least one nozzle 122 is started to irrigate the zone X4 with the at least one nozzle 122 at the fourth angular position P4=132°. During the calibration process of the sprinkler 110, the fourth flowrate F4 is determined using the flow sensor 132. The fourth flowrate F4 may be determined to be 425 liters per hour. The fourth flowrate F4 and the fourth angular position P4 may be stored in the memory 138. Further, during the watering operation of the calibrated sprinkler 110, the controller 136 retrieves the required fourth flowrate F4 and the fourth angular position P4 from the memory 138 to enable the sprinkler 110 to water or irrigate the zone X4 with the desired fourth flowrate F4 and thereby at the target throwing distance d4=6 meters.

Likewise according to an illustrative example, the outflow from the at least one nozzle 122 is started to irrigate the zone X5 with the at least one nozzle 122 at the fifth angular position P5=180°. During the calibration process of the sprinkler 110, the fifth flowrate F5 is determined using the flow sensor 132. The fifth flowrate F5 may be determined to be 320 liters per hour. The fifth flowrate F5 and the fifth angular position P5 may be stored in the memory 138. Further, during the watering operation of the calibrated sprinkler 110, the controller 136 retrieves the required fifth flowrate F5 and the fifth angular position P5 from the memory 138 to enable the sprinkler 110 to water or irrigate the zone X5 at the target throwing distance d5=4 meters.

FIG. 3 illustrates a flowchart illustrating a method 300 of calibrating the water application device 110, particularly the sprinkler 110 that includes the at least one nozzle 122, according to an exemplary embodiment of the present invention. The method 300 is embodied as an algorithm implemented by the controller 136. In other words, the controller 136 may be configured to perform the method 300 of calibrating the sprinkler 110.

In step 302, the method 300 begins. In step 302, the method 300 comprises positioning of the at least one nozzle 122 at the first angular position P1. The method 300 then continues with step 304 to start the outflow, particularly of water, from the at least one nozzle 122. Once the step 304 has been executed, the method 300 then continues with step 306. In step 306, the throwing distance D of the outflow is adjusted. The method 300 then continues with step 308. In step 308, it is evaluated if the throwing distance D adjusted in step 306 substantially corresponds to the target throwing distance d. If the throwing distance D adjusted in step 306 substantially corresponds to the target throwing distance d, then step 310 follows. In step 310, the throwing distance D is confirmed. Further, if the throwing distance D adjusted in step 306 does not corresponds to the target throwing distance d, then step 306 is repeated and the throwing distance D of the outflow is adjusted again.

Further, the method 300 continues with step 312. In step 312, the first flowrate F1 at the confirmed throwing distance (i.e., when D=d) is determined. The first flowrate F1 at the confirmed throwing distance may be determined by the flow sensor 132. The flow sensor 132 measures the flowrate through the at least one nozzle 122 when the flowrate through the at least one nozzle 122 may be sufficient to produce the outflow to reach the target throwing distance d.

The method 300 then continues with step 314. In step 314, the first flowrate F1 together with the first angular position P1 is stored in the memory 138.

Further, the steps of positioning 302, starting 304, adjusting 306, evaluating 308, confirming 310, determining 312, and storing 314 are repeated until the at least one nozzle 122 is calibrated at a pre-determined number of angular positions. In other words, the plurality of steps involved in the calibration of the at least one nozzle 122 may be repeated until the sprinkler 110 may be calibrated to completely irrigate the area A, e.g., the zones X1, X2, X3, X4, and X5 defined along the arbitrarily shaped contour of the area A. The repetition of steps at the pre-determined number of angular positions may further facilitate precise and accurate irrigation or watering, thereby preventing wastage of water.

The method 300 further continues with step 316. In step 316, the outflow from the at least one nozzle 122 is stopped. The method 300 then continues with step 318. In step 318, the controller 136 evaluates if the calibration is done at the pre-determined number of angular positions. If the calibration is done at the pre-determined number of angular positions, then the method 300 continues with step 320. In step 320, the method 300 stops. If the calibration is not yet done at the pre-determined number of angular positions, then the method 300 returns to step 302. In step 302, this time the at least one nozzle 122 is positioned at the second angular position P2 and the further steps according to the method 300 of calibrating are repeated.

The method 300 is repeated for N times, wherein N may be an integer such that when N=1, then the at least one nozzle 122 is positioned at the first angular position P1. Further, when N=2, then the at least one nozzle 122 is positioned at the second angular position P2 and so on until the at least one nozzle 122 is positioned at the pre-determined number N of angular positions.

Further, the first angular position P1 and the second angular position P2 according to the disclosure of the present invention may be distanced from each other by a pre-set angular distance.

Further, the at least one nozzle 122 may be positioned at a pre-determined number of angular positions, such that the flowrate through the at least one nozzle 122 at the pre-determined number of angular positions may be determined. Further, the pre-determined number of angular positions may cover up the complete area A with the arbitrarily shaped contour, e.g., the zones X1, X2, X3, X4, and X5 defined along the arbitrarily shaped contour of the area A. Hence, the sprinkler 110 may be efficiently calibrated for irrigating.

According to an exemplary embodiment of the invention, the adjusting of the throwing distance D may be a manually adjusting of the throwing distance D and/or the adjusting of the throwing distance D may be performed by a user, particularly via a graphical user interface, more particularly running on a mobile device 400.

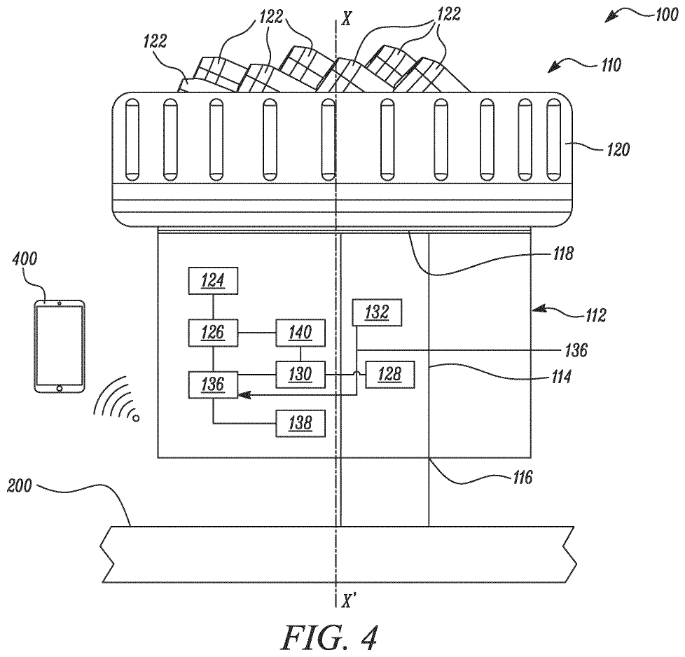

FIG. 4 illustrates a schematic diagram of the irrigation system 100 of FIG. 1 communicably coupled with the mobile device 400.

The user may manually adjust the throwing distance through the at least one nozzle 122 positioned at the particular angular position P. The manual adjustment of the throwing distance D may be based on visual and/or graphical observation of the arbitrarily shaped contour to be watered.

In other words, the user may manually increase or decrease the throwing distance D of the at least one nozzle 122 which may be positioned at the particular angular position P. The manual increase or decrease of the throwing distance D of the at least one nozzle 122 may be done to allow the outflow of the at least one nozzle 122 to reach the target throwing distance d. The manual increase or decrease of the throwing distance D of the at least one nozzle 122 may be done by visual and/or graphical observation and/or analysis. For example, the user may observe that by increasing the throwing distance D, the outflow is reaching beyond the target throwing distance d, or the user may observe that a further increase in the throwing distance D the at least one nozzle 122 is required to allow the outflow to reach the target throwing distance d. Accordingly, the user may manually adjust the throwing distance D by using an application on his mobile device 400.

As illustrated in FIG. 4, the adjusting of the throwing distance D of the outflow may be performed by the user, particularly by using the graphical user interface, more particularly running on the mobile device 400. The user may use the graphical user interface running on the mobile device 400, laptop, and the like, to adjustably control the throwing distance D. Particularly, the graphical user interface may provide various graphical representations of the specified irrigation area A that may assist the user in analysis and adjustment of the throwing distance D. For example, the user may remotely adjust the throwing distance D with the help of the mobile device 400. Further, the mobile device 400 may employ wireless communication technology to allow the user to adjust the throwing distance D of the outflow.

According to an exemplary embodiment of the invention, the target throwing distance d may be determined by the user, particularly by visually determining the target throwing distance d. The user may be physically present at the irrigation area A or may visualize a map of the irrigation area A in the mobile device 400 located at the remote location from the irrigation area A to determine the target throwing distance d. The determined target throwing distance d is then communicated for purpose of calibration of the sprinkler 110.

Confirming the throwing distance D includes manually confirming the throwing distance d, particularly by using the graphical user interface, running on a mobile device 400. According to an example, the user may visualize the real-time image or video of the irrigation area A with the arbitrarily shaped contour. The user may visualize the real-time image or video of the sprinkler operation such as the outflow and visually confirm the throwing distance, i.e., the user may visually confirm that D=d.

Thus, the present disclosure provides the method 300 of calibrating the water application device 110, particularly the sprinkler 110, for irrigating the area A with the arbitrarily shaped or irregular contour. The water application device 110 is a part of intelligent irrigation system 100 that includes controller 136, one or more operational parameter sensors such as the flow sensor 132, and other electronic circuitries to execute the method 300 of calibrating the water application device 110. The method 300 may allow the water application device 110 to selectively and precisely irrigate one or more zones in the area A with arbitrarily shaped contour, such that each of the one or more zones may be at different distances from the water application device 110. The method 300 allows the measurement of flowrate for different zones in the area A with arbitrarily shaped contour. The method 300 may allow for an efficient and quick control and adjustment of the valve 128 fluidly coupled with the at least one nozzle 122 of the water application device 110 to water different zones in the area A with arbitrarily shaped contour. The method 300 may facilitate judicious use of water by precisely irrigating the area A with arbitrarily shaped contour as per requirement. Further, the method 300 may facilitate efficient irrigation of the area A with arbitrarily shaped contour.

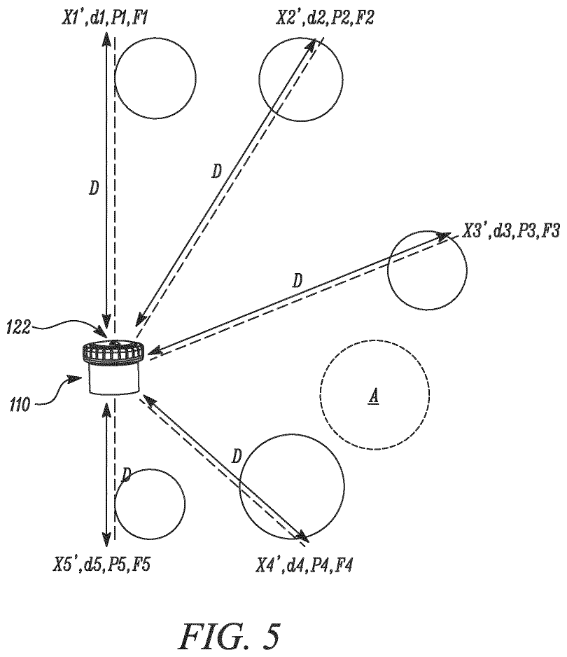

FIG. 5 illustrates a simplified drawing illustrating an exemplary spot irrigation pattern at different throwing distances D from a single spot nozzle 122 of the sprinkler 110 in accordance with an exemplary embodiment of the present disclosure. The sprinkler 110 comprises a single nozzle 122 which is formed as a spot nozzle 122. The sprinkler 110 comprising the single spot nozzle 122 is configured to irrigate different spot-shaped zones X1′, X2′, X3′, X4′, and X5′ of the area A, wherein each of the different zones X1′, X2′, X3′, X4′, and X5′ is a spot-shaped zone at different throwing distances D.

As an illustrative example as shown in FIG. 5, the spot-shaped zone X1′ requires the target throwing distance d1=8 meters for irrigation, the single spot nozzle 122 is positioned at the first angular position P1=0°, and the exemplarily determined first flowrate F1 is 525 liters per hour. The spot-shaped zone X2′ may require the target throwing distance d2=9.4 meters for irrigation, the single spot nozzle 122 is positioned at the second angular position P2=32°, and the exemplarily determined second flowrate F2 is 595 liters per hour. The spot-shaped zone X3′ may require the target throwing distance d3=8.5 meters for irrigation, the single spot nozzle 122 is positioned at the third angular position P3=68°, and the exemplarily determined third flowrate F3 is 550 liters per hour. The spot-shaped zone X4′ may require the target throwing distance d4=6 meters for irrigation, the single spot nozzle 122 is positioned at the fourth angular position P4=132°, and the exemplarily determined fourth flowrate F4 is 425 liters per hour. The spot-shaped zone X5′ may require the target throwing distance d5=4 meters for irrigation, the single spot nozzle 122 is positioned at the fifth angular position P5=180°, and the exemplarily determined fifth flowrate F5 is 320 liters per hour. Hence, the respective target throwing distance d1, d2, d3, d4, d5, the respective angular position P1, P2, P3, P4, P5, and the respective determined flowrate F1, F2, F3, F4, F5 of the spot-shaped zones X1′, X2′, X3′, X4′, X5′ are similar to the ones described with reference to the zones X1, X2, X3, X4, X5 in FIG. 2.

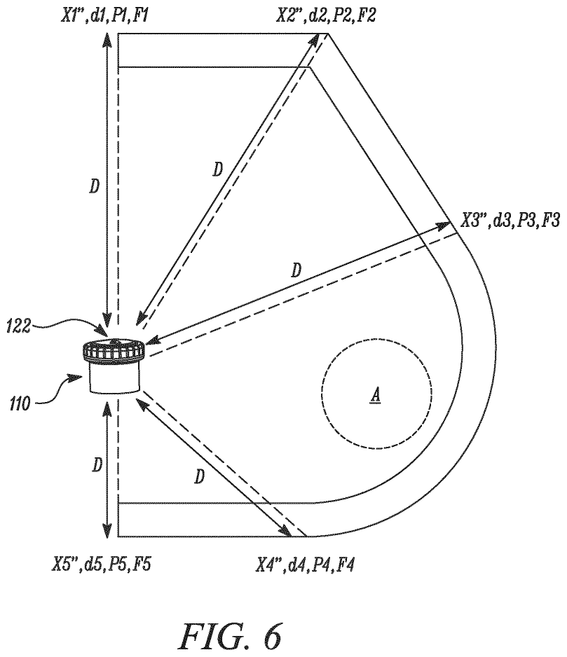

FIG. 6 illustrates a simplified drawing illustrating an exemplary strip irrigation pattern at different throwing distances D from a further single spot nozzle 122 of the sprinkler 110 in accordance with an exemplary embodiment of the present disclosure. The sprinkler 110 comprises a single nozzle 122 which is formed as a spot nozzle 122. The sprinkler 110 comprising the single spot nozzle 122 is configured to irrigate different strip-shaped zones X1″, X2″, X3″, X4″, and X5″ of the area A, wherein each of the different zones X1″, X2″, X3″, X4″, and X5″ is a strip-shaped zone at different throwing distances D.

As an illustrative example as shown in FIG. 6, the strip-shaped zone X1″ requires the target throwing distance d1=8 meters for irrigation, the further single spot nozzle 122 is positioned at the first angular position P1=0°, and the exemplarily determined first flowrate F1 is 525 liters per hour. The strip-shaped zone X2″ may require the target throwing distance d2=9.4 meters for irrigation, the further single spot nozzle 122 is positioned at the second angular position P2=32°, and the exemplarily determined second flowrate F2 is 595 liters per hour. The strip-shaped zone X3″ may require the target throwing distance d3=8.5 meters for irrigation, the further single spot nozzle 122 is positioned at the third angular position P3=68°, and the exemplarily determined third flowrate F3 is 550 liters per hour. The strip-shaped zone X4″ may require the target throwing distance d4=6 meters for irrigation, the further single spot nozzle 122 is positioned at the fourth angular position P4=132°, and the exemplarily determined fourth flowrate F4 is 425 liters per hour. The strip-shaped zone X5″ may require the target throwing distance d5=4 meters for irrigation, the further single spot nozzle 122 is positioned at the fifth angular position P5=180°, and the exemplarily determined fifth flowrate F5 is 320 liters per hour. Hence, the respective target throwing distance d1, d2, d3, d4, d5, the respective angular position P1, P2, P3, P4, P5, and the respective determined flowrate F1, F2, F3, F4, F5 of the strip-shaped zones X1″, X2″, X3″, X4″, and X5″ are similar to the ones described with reference to the zones X1, X2, X3, X4, and X5 in FIG. 2.

In the drawings and specification, there have been disclosed exemplary embodiments and examples of the invention and, although specific terms are employed, they are used in a generic and descriptive sense only and not for the purpose of limitation of the scope of the invention being set forth in the following claims.

### LIST OF ELEMENTS

100 Irrigation System
110 Water Application Device, Sprinkler
112 Body
114 Water Channel
116 Inlet
118 Outlet
120 Sprinkler Head
122 Nozzle
124 Drive Mechanism
126 Motor
128 Valve
130 Motor
132 Flow Sensor
134 Output Signal
136 Controller
138 Memory
140 Power Supply
200 Water Supply Line
300 Method
302 Step
304 Step
306 Step
308 Step
310 Step
312 Step
314 Step
316 Step
318 Step
320 Step
400 Mobile Device
X-X′ Central Axis
D Throwing Distance
d Target throwing distance
d1 First Target Throwing Distance
d2 Second Target Throwing Distance
d3 Third Target Throwing Distance
d4 Fourth Target Throwing Distance
d5 Fifth Target Throwing Distance
X1, X2, X3, X5, X5 Zone
P1 First Angular Position
P2 Second Angular Position
P3 Third Angular Position
P4 Fourth Angular Position
P5 Fifth Angular Position
F1 First Flowrate
F2 Second Flowrate
F3 Third Flowrate
F4 Fourth Flowrate
F5 Fifth Flowrate

1. A method of calibrating a water application device, particularly a sprinkler,
wherein the water application device comprises at least one nozzle, the method comprising:
positioning the at least one nozzle at a first angular position;
starting an outflow, particularly of water, from the nozzle;
adjusting a throwing distance of the outflow;
if the throwing distance substantially corresponds to a target throwing distance (d), confirming the throwing distance; wherein:
determining a first flowrate at the confirmed throwing distance; and storing the first flowrate together with the first angular position.

2. The method according to claim 1,
wherein the adjusting of the throwing distance is a manually adjusting of the throwing distance, and/or
wherein the adjusting of the throwing distance is performed by a user, particularly via a graphical user interface, more particularly running on a mobile device.

3. The method according to claim 1, wherein the steps of positioning, starting, adjusting, confirming, determining and storing are repeated until the at least one nozzle is calibrated at a pre-determined number of angular positions.

4. The method according to claim 1, the method further comprises stopping the outflow from the nozzle, and subsequently, positioning the at least one nozzle at a second angular position, in particular wherein the first angular position and the second angular position are distanced from each other by a pre-set angular distance.

5. The method according to claim 1, wherein the first flowrate at the confirmed throwing distance is determined by a flow sensor.

6. The method according to claim 1, wherein adjusting the throwing distance of the outflow is performed by a user, particularly by using a graphical user interface, more particularly running on a mobile device.

7. The method according to claim 1, wherein the target throwing distance is determined by a user, particularly by visually determining the target throwing distance.

8. The method according to claim 1, wherein confirming the throwing distance comprises manually confirming the throwing distance, particularly by using a graphical user interface, in particular running on a mobile device.

9. A controller configured to perform the method of calibrating a water application device according to claim 1.

10. An irrigation system comprising a water application device, a controller according to claim 9, and a memory, wherein the controller is configured to communicate with the memory, wherein the first flowrate together with the first angular position is stored in the memory.

11. The irrigation system according to claim 10, wherein the water application device is a sprinkler comprising:
a body defining a water channel, wherein the water channel is defined between an inlet and an outlet of the body to allow a flow of water;
a sprinkler head fluidly coupled to the body; and at least one nozzle disposed with the sprinkler head.

12. The irrigation system according to claim 10, wherein the angular position of the at least one nozzle is adjustable with adjustment in position of the sprinkler head.

13. The irrigation system according to claim 10, wherein a magnitude of a throwing distance of at least one nozzle at a particular angular position is directly linked to the flowrate through the at least one nozzle.

14. The irrigation system according to claim 10, wherein a flow sensor determines the flowrate through the at least one nozzle, if the throwing distance substantially corresponds to a target throwing distance.

15. The irrigation system according to claim 10, wherein the controller is communicably coupled with the flow sensor.
